(19) United States
(12) Patent Application Publication
(10) Pub. No.: US 2006/0164776 A1
(43) Pub. Date: Jul. 27, 2006

(54) Current-limiting circuit and method for operating the circuit

(75) Inventor: Bernhard Erdl, Munchen (DE)

Correspondence Address: MILES & STOCKBRIDGE PC, 1751 PINNACLE DRIVE, SUITE 500, MCLEAN, VA, 22102-3833, US

(73) Assignee: Puls GmbH, Munchen (DE)

(21) Appl. No.: 11/332,462

(22) Filed: Jan. 17, 2006

(30) Foreign Application Priority Data
Jan. 18, 2005 (DE) DE102005002359.2

(51) Int. Cl. H02H 3/08

(52) U.S. Cl. 361/93.1

(57) ABSTRACT

A current-limiting circuit, including a switch, a diode, an inductance, an input with a first connection and second connection, and an output with a first connection and second connection. The first connection of the input is connected via the switch to the inductance and to the cathode of the diode and is connected via the inductance to the first connection of the output. In addition, the anode of the diode is connected to the second connection of the input and to the second connection of the output.

The invention relates to a current-limiting circuit and a method for operating the circuit.

The essential challenge is to limit a switch-on current for an electrical power-consuming component, e.g. an electrical device. Immediately after the electrical power-consuming component is switched on, for example, capacitors are charged, which temporarily results in a high electrical load on the supply, the power-consuming component, and the (external) switch in particular. On the one hand, the powerful load on the supply is undesirable and on the other hand, it is disadvantageous that the affected parts of the power-consuming component must be designed to withstand this high current, which is many times greater than the current during normal operation. It is therefore known, for example from [1], to provide a limitation of the switch-on current in order to reduce the supply system load during the switching-on of the power-consuming component. To that end in [1], a field effect transistor is suitably triggered so that the field effect transistor is at most encumbered with a predeterminable maximum power loss.

It is disadvantageous here that the field effect transistor operates in a linear mode and therefore generates significant losses.

Also, according to the standard EN610003-3, the switch-on current must not exceed predetermined values.

The object of the invention is to disclose a circuit for effectively limiting current without high losses and a method for operating this circuit.

This object is attained according to the defining characteristics of the independent claims. Modifications of the invention are disclosed in the dependent claims.

In order to attain the object of the invention, a current-limiting circuit is disclosed, which includes a switch, a diode, an inductance, an input with a first connection and second connection, and an output with a first connection and second connection. The first connection of the input is connected via the switch to the inductance and to the cathode of the diode and is connected via the inductance to the first connection of the output. In addition, the anode of the diode is connected to the second connection of the input and to the second connection of the output.

The above-described wiring of the component in question is particularly suitable for use as a clocked current limitation device. It is thus possible, with a high frequency triggering of the switch, to use a correspondingly low inductance. It is also advantageous when a predetermined current threshold is exceeded to open the switch and thus disconnect the output from the input. This can advantageously occur both during the switch-on phase and also during operation of the circuit, e.g. when a power-consuming component is connected to the output.

It should be noted here that the present current-limiting circuit can be used preferably as a component of a circuit, in particular of an electrical power-consuming component. Preferably, the circuit here is used in a power supply, in particular in a power pack or a (clocked) switched mode power supply. Another possible use for the circuit is to permit this power supply, in particular the switched mode power supply, to be mounted on a mounting rail and/or mounted in a switching cabinet.

Preferably, the circuit can be a circuit for clocked current limitation.

In one embodiment, the switch is comprised of at least one electronic switch, in particular a transistor, a MOSFET, a thyristor, or an IGBT. It is also possible for the electronic switch to be a combination of several switches, in particular electronic switches.

In another embodiment, a resistor is connected between the switch and the cathode of the diode and/or the inductance. This resistor is particularly suitable for use as a measurement resistor for measuring current and consequently for triggering the (electronic) switch.

In one particular embodiment, the inductance is an inductance of a filter, in particular a component of a high frequency filter (HF filter). This is advantageous since the HF filter already has an inductance that the circuit can also use for current limitation, thus eliminating the need for providing an additional inductance.

In particular the current-limiting circuit can be placed between two capacitors of an HF filter.

In one modification, the input of the current-limiting circuit is preceded by a rectifier circuit.

In another modification, a capacitor is provided at the output of the current-limiting circuit. In particular, this capacitor can be an electrolytic capacitor (“buffer capacitor”). In another embodiment, the switch charges this capacitor in a clocked fashion, the clock speed serving to limit the current flowing through the circuit.

In one embodiment, a power factor correction circuit is connected to the output of the current-limiting circuit.

The power factor correction circuit can preferably be embodied in the form of a boost converter equipped with a suitable triggering mechanism. In particular, the power factor correction includes at least one electronic circuit, e.g. a transistor, a MOSFET, a thyristor, or an IGBT.

The object of the invention is also attained by means of a current-limiting method, in particular by means of triggering the above-describe circuit, in which the switch is preferably opened when a predetermined current threshold is exceeded.

Preferably, the instantaneous current is measured by a resistor.

In one embodiment, at least some of the time, the switch is closed and opened at a predetermined clock speed.

In one modification, the switch is triggered by at least one pulse generator and/or at least one Schmitt trigger or at least one comparator. Preferably, the clock speed can have an (optionally variable) frequency of approx. 1 KHz to approx. 1 MHz.

In another modification, the cyclical closing and opening of the switch serves to charge at least one capacitor (buffer capacitor).

In another modification, the circuit is used to limit switch-on current and/or to detect transients.

It should be noted here that the term overvoltage is intended herein to apply to all forms of voltages greater than a predetermined supply voltage, in particular a line voltage, and all forms of voltage spikes. In particular, the term “transient” is intended to apply to all types of chronologically limited overvoltages that deviate from the target values of the electrical supply voltage. It should additionally be noted that an overvoltage can also stem from a current spike.

Particularly when circuits, devices, or power-consuming components are supplied by electrical networks, it is necessary to protect them from overvoltages, in particular overvoltage pulses. Such a pulse is defined, for example in the standard EN61000-4-5, as having a rise time of 1.2 μs and a half value time of 50 μs and can occur, for example, when lightning strikes. The standard VDE 0160W2 describes another known pulse with a peak voltage of 747 volts (rise time 100 μs, half value time 1.3 μs), which, as a pure voltage pulse, supplies a (theoretically infinitely) high current.

Exemplary embodiments of the invention will be explained below in conjunction with the drawings.

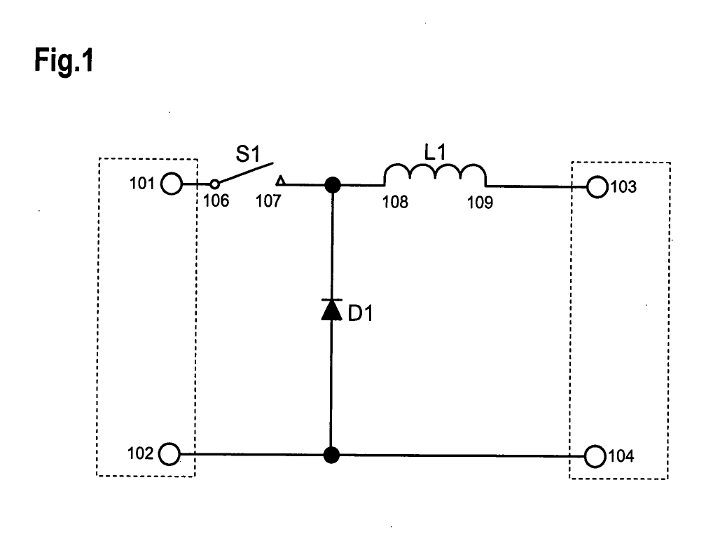

FIG. 1 is a circuit diagram of a current-limiting circuit;

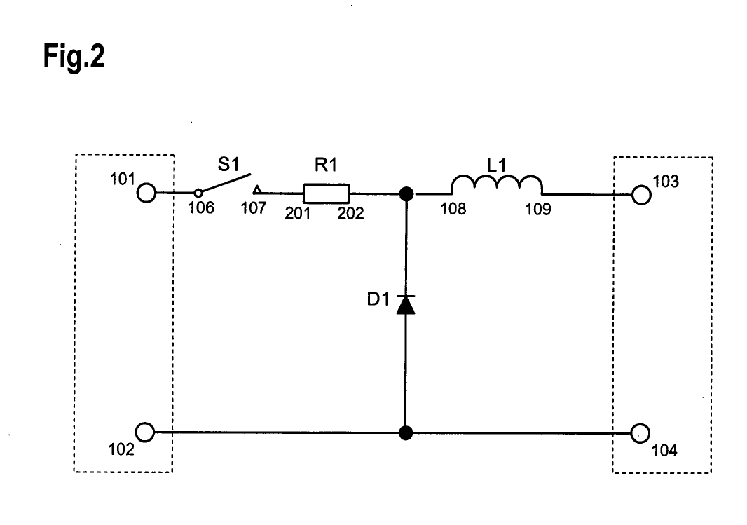

FIG. 2 is a circuit diagram of an alternative current-limiting circuit;

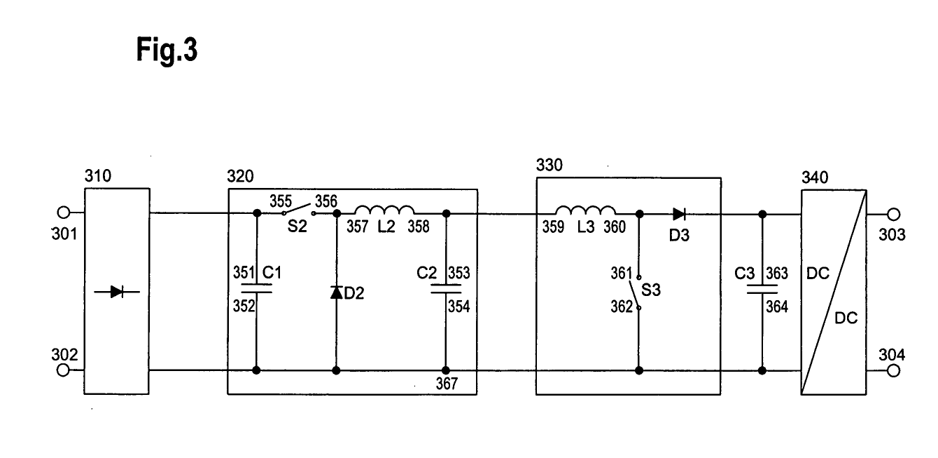

FIG. 3 is a circuit diagram of a power supply equipped with a current-limiting circuit;

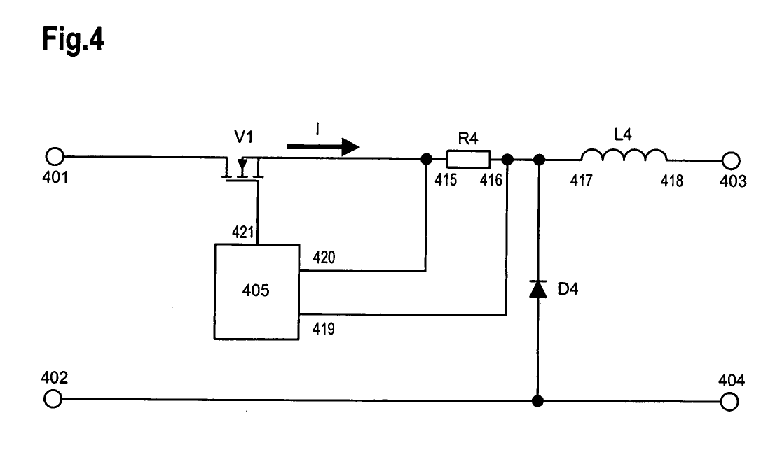

FIG. 4 is a circuit diagram of a current-limiting circuit equipped with an electronic switch;

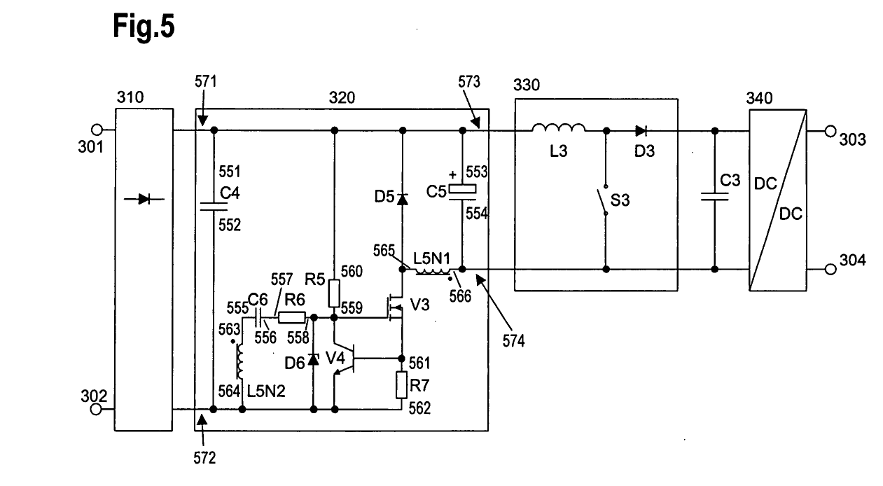

FIG. 5 is a detailed circuit diagram of a current-limiting circuit equipped with an electronic switch.

FIG. 1 shows a circuit diagram of a current-limiting circuit, including an input with connections 101 and 102, an output with connections 103 and 104, a switch SI with connections 106 and 107, an inductance L1 with connections 108 and 109, and a diode D1.

The connection 101 of the input is connected to the output 106 of the switch S1, while the connection 107 of the switch S1 is connected to the connection 108 of the inductance L1 and to the cathode of the diode D1. The connection 109 of the inductance L1 is connected to connection 103 of the output. In addition, the anode of the diode D1 is connected to the connection 102 of the input and to the connection 104 of the output.

The circuit diagram in FIG. 1 illustrates the principal arrangement of components for (clocked) current limitation. The switch S1 can in particular be embodied in the form of an electronic switch that opens if the current exceeds a predetermined threshold. To that end, the preferably electronic switch S1 is provided with a suitable triggering mechanism. The switch S1 is closed and reopened at a predetermined frequency, which assures operation of the circuit, in particular the power-consuming component connected to the output via the connections 103 and 104, even at a current above the threshold. This frequency effectively limits the flow of current through the circuit, in particular the current provided to the power-consuming component via the connections 103 and 104. Such a limiting suitably occurs during the switching-on process of the circuit and/or of the power-consuming component (e.g. for charging possibly drained capacitors) and/or during operation of the circuit, in the event of the (sudden) occurrence of powerful currents (e.g. due to overvoltage pulses or transients).

FIG. 2 shows a circuit diagram of a modified current-limiting circuit. By contrast with FIG. 1, this is additionally provided with a resistor R1 equipped with the connections 201 and 202. The connection 201 of the resistor R1 is connected to the connection 107 of the switch S1, while the connection 202 of the resistor R1 is connected to the connection 108 of the inductance L1 and to the cathode of the diode D1. Consequently, the connection 107 of the switch S1 is no longer connected to the inductance L1 and the diode D1 as shown in FIG. 1; instead, the resistor R1 is situated between the connection 107 of the switch S1 from FIG. 1 and the node point between the inductance L1 and the diode D1.

The resistor R1 is preferably embodied in the form of a measurement resistor for detecting the current flowing through it. A current detected in this fashion can be used to trigger the (in particular electronic) switch S1.

FIG. 3 shows a circuit diagram of a power supply equipped with a current-limiting circuit. The circuit diagram from FIG. 3 shows an input with the connections 301 and 302 and an output with the connections 303 and 304. The circuit is also provided with a rectifier 310, a unit 320 (embodied in the form of a high-frequency filter (HF filter) equipped with a current-limiting circuit), a power factor correction (unit) 330 (for example embodied in the form of a boost converter), a capacitor C3 (“buffer capacitor”), in particular embodied in the form of an electrolytic capacitor, and a transformer or DC/DC converter 340.

The rectifier 310 is connected to the connections 301 and 302 of the input. The rectifier 310 converts the preferably supplied alternating current signal into a direct current signal and transmits it to the HF filter equipped with the current-limiting circuit 320.

The unit 320 includes a capacitor C1 (with connections 351 and 352), a capacitor C2 (with connections 353 and 354), a diode D2, a switch S2 (with connections 355 and 356), and an inductance L2 (with connections 357 and 358).

The capacitor C1 is connected in parallel with the input of the unit 320, while the connection 351 of the capacitor C1 is connected to the connection 355 of the switch S2. The connection 356 of the switch S2 is connected to the cathode of the diode D2 and to the connection 357 of the inductance L2. The capacitor C2 is connected in parallel to the output of the unit 320, while the connection 353 of the capacitor C2 is connected to the connection 358 of the inductance L2. The connection 354 of the capacitor C2 is connected to the connection 352 of the capacitor C1 and the anode of the diode D2. This shared connection point is also referred to as node 367.

If the unit 320 is considered to be a quadripole, i.e. a unit with an input and output—each of which has two connections, then the input on the one hand includes an attachment of the connection 351 of the capacitor C1 to the connection 355 of the switch S2 and on the other hand, includes an attachment of the connection 351 of the capacitor C1 to the anode of the diode D2 and to the connection 354 of the capacitor C2 (this corresponds to the node 367). The output on the one hand includes an attachment of the connection 358 of the inductance L2 to the connection 353 of the capacitor C2 and on the other hand, includes an attachment to the node 367.

The power factor correction 330 includes an inductance L3 (with connections 359 and 360), a switch S3 (with connections 361 and 362), and a diode D3.

The connection 359 of the inductance L3 is connected to the connection 353 of the capacitor C2 (and to the connection 358 of the inductance L2). The connection 360 of the inductance L3 is connected to the connection 361 of the switch S3 and to the anode of the diode D3. The connection 362 of the switch S3 is connected to the connection 354 of the capacitor C2 (and to the anode of the diode D2, to the connection 352 of the capacitor C1, and to the output of the rectifier 310, and thus to the node 367).

The switch S3 is preferably embodied in the form of electronic switch, in particular a transistor, a MOSFET, a thyristor, or an IGBT. A suitable triggering mechanism assures that the boost converter counteracts the capacitive and/or inductive resistances of the circuit (e.g. see [2]).

The “buffer capacitor” C3, in particular embodied in the form of an electrolytic capacitor, includes the connections 363 and 364; the connection 363 of the capacitor C3 is connected to the cathode of the diode D3 and to the input of the transformer 340. The connection 364 of the capacitor C3 is connected to the node 367 and to the other input of the transformer 340. Consequently, the connections 363 and 364 of the capacitor C3 are connected in parallel to the input of the transformer 340. At the output of the transformer 340, the connections 303 and 304 are supplied (in a controllable fashion) with the converted direct current, in particular in a range from for example 3 volts to 48 volts.

The transformer 340 can in particular be embodied in the form of a direct current converter, e.g. a flyback converter, a flow converter, or a push-pull converter.

The unit 320 includes the switch S2, the inductance L2, and the current-limiting diode D2, these components comprising parts of the HF filter. In particular, the inductance L2 is both a component of the HF filter (in connection with the capacitors C1 and C2) and a component of the current-limiting circuit.

With a suitable clock cycle of the switch S2, during the switching-on process, the capacitor C3 can be charged in a controlled fashion, i.e. so that the current does not exceed a predetermined threshold.

Alternatively, the secondary side of the DC/DC converter 340 can be provided with the current-limiting circuit, e.g. as in FIG. 1, in order to prevent short circuits in the power supply.

FIG. 4 shows a circuit diagram of a current-limiting circuit equipped with an electronic switch.

FIG. 4 includes an input with connections 401 and 402, an output with connections 403 and 404, a resistor R4 (with connections 415 and 416), an n-channel MOSFET V1, a diode D4, an inductance L4 (with connections 417 and 418), and a triggering unit 405 (with inputs 419, 420 and an output 421).

The connection 401 of the input is connected to the drain connection of the MOSFET V1. The source connection of the MOSFET V1 is connected to the connection 415 of the resistor R4 and the input 420 of the triggering unit 405. The connection 416 of the resistor R4 is connected to the input 419 of the triggering unit 405, to the connection 417 of the inductance L4, and to the cathode of the diode D4. The connection 418 of the inductance L4 is connected to the connection 403 of the output. The anode of the diode D4 is connected to the connection 402 of the input and to the connection 404 of the output. The output 421 of the triggering unit 405 is connected to the gate connection of the MOSFET V1.

Operation of the Circuit According to FIG. 4:

The MOSFET V1 is the electronic switch for the current limitation. If the current I passing through the measurement resistor R4 exceeds a predetermined threshold, then the triggering unit 405 disconnects the MOSFET V1. The current passing through the resistor R4 is detected and evaluated by the inputs 419 and 420 of the triggering unit 405. In accordance with the evaluated signal, the triggering unit 405 switches the MOSFET V1 into the conductive and/or nonconductive state.

But to prevent this from resulting in a permanently nonconductive state, the triggering unit triggers the MOSFET V1 so that it closes and opens again with an (in particular variable) frequency; the frequency with which the MOSFET V1 is triggered determines the current I. Through a suitable selection of the frequency, it is thus possible to regulate and in particular, limit the current I. If the current I is greater than a predetermined threshold, then the triggering unit 405 performs a regulating function; for example at least one comparator in the control unit 405 is used to influence the frequency for the triggering of the MOSFET V1. Alternatively, at least one Schmitt trigger in the triggering unit 405 can be used, for example, to generate a hysteresis for a control procedure.

It is thus possible with the circuit according to FIG. 4 not only to detect and limit overvoltages and current surges, but also to limit the current during the switching-on process, e.g. when the connections 403 and 404 of the output contain a number of drained that require charging at the beginning.

FIG. 5 shows a detailed circuit diagram of a current-limiting circuit equipped with an electronic switch. In some regions, FIG. 5 corresponds to the above-described FIG. 3; in particular, the rectifier 310, the power factor correction 330, the buffer capacitor C3, and the transformer or converter 340 correspond to those described in conjunction with FIG. 3. The connections 301 and 302 of the input and the connections 303 and 304 of the output have also been described in conjunction with FIG. 3. The difference in relation to FIG. 3 lies in the detailed wiring of the unit 320, which has an HF filter and a current-limiting circuit, in particular for limiting the switching-on current and for disconnecting transients.

To that end, the unit 320 includes a capacitor C4 (with connections 551 and 552), an electrolytic capacitor C5 (with connections 553 (positive pole) and 554), a capacitor C6 (with connections 555 and 556), a resistor R5 (with connections 559 and 560), a resistor R6 (with connections 557 and 558), a resistor R7 (with connections 561 and 562), a primary winding of an inductance L5 (with connections 565 and 566), and a secondary winding N1 of the inductance L5 (with connections 563 and 564). A diode D5, a Zener diode D6, an n-channel MOSFET V3, and an npn-transistor V4 are also provided.

For the sake of a more comprehensive overview, the unit 320 also has an input with connections 571 and 572 and an output with connections 573 and 574.

The connection 551 of the capacitor C4 is connected to the connection 571 of the input, to the connection 560 of the resistor R5, to the cathode of the diode D5, to the connection 553 of the capacitor C5, and to the connection 573 of the output. The connection 552 of the capacitor C4 is connected to the connection 572 of the input, to the connection 564 of the secondary winding N2 of the inductance L5, to the anode of the Zener diode D6, to the emitter of the transistor V4, and to the connection 562 of the resistor R7. The connection 554 of the capacitor C5 is connected to the connection 566 of the primary winding N1 of the inductance L5 and to the connection 574 of the output. The connection 565 of the primary winding N1 of the inductance L5 is connected to the drain connection of the MOSFET V3 and to the anode of the diode D5. The connection 563 of the secondary winding N2 of the inductance L5 is connected to connection 555 of the capacitor C6. The connection 556 of the capacitor C6 is connected to the connection 557 of the resistor R6. The connection 558 of the resistor R6 is connected to the cathode of the Zener diode D6, to the connection 559 of the resistor R5, to the collector of the transistor V4, and to the gate connection of the MOSFET V3. The source connection of the MOSFET V3 is connected to the base of the transistor V4 and to the connection 561 of the resistor R7.

The input of the unit 320 is connected to the rectifier 310 according to the description associated with FIG. 3 and the output of the unit 320 is connected to the power factor correction 330 according to (the description of) FIG. 3.

Operation of the Circuit According to FIG. 5:

The circuit from FIG. 5 uses the MOSFET V3 to disconnect the output of the unit 320 from its input if a current greater than a predetermined threshold would otherwise flow.

Switching-On of the MOSFET V3:

The capacitor C6 is charged by the operating voltage via the resistors R5 and R6 as long the threshold voltage reaches the gate connection of the MOSFET V3, whereupon the MOSFET V3 is switched into a linearly conductive state. In the primary winding of the inductance L5N1, a voltage is generated, which, depending on the turns ratio, is also present in the secondary winding L5N2 and thus also activates the gate connection of the MOSFET V3. This results in a positive feedback effect, i.e. as soon as the gate connection of the MOSFET V3 has exceeded its threshold voltage and switches into the conductive state, the positive feedback via the secondary winding L5N2 reinforces the switching into the conductive state.

Switching-Off of the MOSFET V3:

If the MOSFET V3 is switched into the conductive state, then a current flows through the measurement resistor R7. As soon as the base of the transistor V4 reaches the threshold voltage in relation to the emitter, the transistor V4 begins to switch into a conductive state. The MOSFET V3 switches into the nonconductive state, whereupon the voltage in the primary winding L5N1 (and therefore also in the secondary winding L5N2) reverses polarity. This in turn results in a positive feedback of the transistor V4 until the capacitor C6 is discharged and the base of the transistor V4 is no longer positive in relation to the emitter. Alternatively, in lieu of the transistor V4, it is also possible to provide a thyristor, which is triggered with a predetermined gate triggering voltage and then switches the MOSFET V3 into the nonconductive state. The thyristor can be switched off again as a function of the voltage in the primary winding L5N1.

### BIBLIOGRAPHY

[1] DE 2000 10 283 U1
[2] Power factor correction, see: www.tpub.com/neets/book2/4k.htm

1. A current-limiting circuit, comprising
a switch (S1),
a diode (D1),
an inductance (L1),
an input having a first input connection (101) and second input connection (102),
an output having a first output connection (103) and second output connection (104),
the first input connection (101) being connected through the switch (S1) to the inductance (L1) and to the cathode of the diode (D1) and through the inductance (L1) to the first output connection (103) and
the anode of the diode (D1) is connected to the second input connection (102) and to the second output connection (104) of the output.

2. The current limiting circuit as recited in claim 1, wherein the switch (S1) comprises at least one electronic switch.

3. The current limiting circuit as recited in claim 2, wherein the electronic switch is selected from this group comprising a transistor, a MOSFET, a thyristor, and an IGBT.

4. The current limiting circuit as recited in claim 1, wherein a resistor (R1) is connected between the switch and a junction of the cathode of the diode (D1) and a first end of the inductance (L1).

5. The current limiting circuit as recited in claim 1, wherein the inductance (L1) is an inductance a component of a high frequency filter.

6. The current limiting circuit as recited in claim 1, wherein the circuit is operatively disposed between two capacitors (C1, C2) of a high frequency filter.

7. The circuit as recited in claim 1 wherein the first and second input connections of the input are connected to is a preceding rectifier circuit (310).

8. The circuit as recited in claim 1 wherein an electrolytic capacitor is connected across the first and the second output connections the output.

9. The circuit as recited in claim 8, wherein the switch (S1) is connected so as to cause the capacitor (C2, C3) to be charged in a clocked fashion, at a clock speed that serves to limit current flowing through the circuit.

10. The circuit as recited in claim 1 wherein a power factor correction circuit (330) is connected across the first and the second output connections of the output.

11. The circuit as recited in claim 1 wherein the output is connected to a power supply.

12. The circuit as recited in claim 10, wherein the power supply is a switched mode power supply.

13. The circuit as recited in claim 1 wherein the switch (S1) is operatively connected for clocked current limitation.

14. A method for triggering a current-limiting circuit including a switch (S1), a diode (1), an inductance (L1) an input having a first input connection (101) and second input connection (102), an output having a first output connection (103) and second output connection (104), the first input connection (101) being connected through the switch (S1) to the inductance (L1) and to the cathode of the diode (D1) and through the inductance (L1) to the first output connection (103) and the anode of the diode (D1) is connected to the second input connection (102) and to the second output connection (104) of the output, comprising connecting the output to a power supply and opening the switch (S1) when a predetermined voltage threshold at the input is exceeded.

15. The method as recited in claim 14, further including measuring an instantaneous current through a resistor (R1) connected in series with switch (S1) and controlling the switch (S1) in response to the measured current.

16. The method as recited in claim 14, wherein the switch (S1) is closed and reopened at a predetermined clock speed.

17. The method as recited in claim 15, wherein the switch (S1) is closed and reopened at a predetermined clock speed.

18. The method as recited in claim 17, wherein the predetermined clock speed is a frequency in a range from 1 KHz to 1 MHz.

19. The method as recited in claim 14 further including deriving a pulse from the group comprising the switch (S1) by at least one pulse generator, at least one Schmitt trigger, and at least one comparator and triggering the switch (S1) by the derived pulse.

20. The method as recited in claim 16, wherein cyclical closing of the switch (S1) charges at least one capacitor (C2, C3).

21. The method as recited in claim 14 further including limiting switch-on current and detecting transients to an output load circuit.
